(19) United States
(12) Patent Application Publication
(10) Pub. No.: US 2011/0030146 A1
(43) Pub. Date: Feb. 10, 2011

(54) REVERSIBLE SOCKET WRENCH

(76) Inventor: San-Shien Wu, Taipei (TW)

Correspondence Address: San-Shien Wu, 235 Chung - Ho, Box 8-24, Taipei, TW

(21) Appl. No.: 12/534,872

(22) Filed: Aug. 4, 2009

(51) Int. Cl. B25F 1/00; B25B 13/46; B25B 23/16

(52) U.S. Cl. 7/138; 81/63.1; 81/437; 81/177.4; 407/29.1

(57) ABSTRACT

A reversible socket wrench is disclosed having a file formed integral with the transverse part of the T-shaped body thereof for smoothing damaged surface or border edge of a skateboard and an adapter hex wrench detachably attached to the socket at the link at the longitudinal part of the T-shaped body by magnetic attraction and used for rotating the socket-head king pin of a skateboard.

### BACKGROUND OF THE INVENTION

1. Field of the Invention:

The present invention relates to socket wrenches and more particularly, to a reversible socket wrench, which has file fixedly located on the head of the T-shaped body thereof for smoothing a damaged surface or border edge of a skateboard.

2. Description of the Related Art:

Following the step of economic development, people's requirement for tool has been changed from the level of workable to the level of ease and convenience of use with inexpensive characteristic. In consequence, old designs of wrenches for fastening/unfastening screws of a skateboard can no longer satisfy people's demands. An old type socket wrench must be attached the tool to the screw and removed from the screw several times before fastening tight and fully unfastened the screw. This operation manner is inconvenient. Further, a skateboard uses many different sizes of screws at different locations. It may be inconvenient to operate an old type socket wrench in a particular direction when fastening or unfastening a screw at a particular location at a skateboard.

There is known a ratchet wrench adapted for fastening/unfastening two different sizes of screw bolts and nuts. However, this design of ratchet wrench is not convenient for use in the maintenance or repair work of a skateboard.

Further, when using a skateboard, people may perform skating stunts. When performing a skating stunt, the screws of the skateboard may be loosened upon an impact. An accident may occur if the screws of a skateboard are loosened. Further, a new skateboard may have a coarse surface or border edges that must be smoothed, avoiding injury. Further, when riding a skateboard to perform a skating stunt, the border edges of the skateboard may be damaged easily upon an impact. In this case, the damaged borer edges of the skateboard must be quickly smoothed, avoiding injury. For smoothing the surface or damaged border edges of a skateboard, a file shall be used. Thus, people may have to prepare many different tools for the maintenance or repair of a skateboard. It is inconvenient and not economic to prepare many different tools for the maintenance or repair of a skateboard.

Therefore, there is a strong demand for a multipurpose tool, which is practical for the maintenance and repair of a skateboard.

### SUMMARY OF THE INVENTION

The present invention has been accomplished under the circumstances in view. It is one object of the present invention to provide a socket wrench, which is reversible, facilitating skateboard maintenance. It is another object of the present invention to provide a reversible socket wrench, which is practical for fastening/unfastening the king pin of a skateboard and the screw in the king pin of a skateboard. It is still another object of the present invention to provide a reversible socket wrench, which has an integrated file for smoothing the surface of a new skateboard or damaged border edge of an old skateboard, avoiding accidental injury.

To achieve these and other objects of the present invention, a reversible socket wrench comprises a T-shaped body, which has a recessed portion located on the transverse part thereof for receiving a tool, a first socket fixedly located on one end of the transverse part for rotating a king pin of a skateboard and a second socket fixedly located on an opposite end of the transverse part for rotating a predetermined size of screw bolts and nuts, a file fixedly mounted on the periphery of the transverse part of the T-shaped body a for smoothing the surface of a new roller skate or damaged border edges of an old skateboard, a cap capped on one end of the longitudinal part of the T-shaped body, a link coupled to the cap and having a gear disposed at one end thereof and received inside the cap and a socket located on an opposite end thereof, and a ratchet wheel set mounted in the cap for controlling direction of rotation of the link relative to the T-shaped body.

Further, an adapter hex wrench is detachably attached to the socket at the link by magnetic attraction and adapted for rotating a socket head king pin of a skateboard.

### BRIEF DESCRIPTION OF THE DRAWINGS

FIG. 1 is an elevational view of a reversible socket wrench in accordance with the present invention.

FIG. 2 illustrates a status of use of the reversible socket wrench for a skateboard maintenance work in accordance with the present invention.

FIG. 3 is an exploded view of the reversible socket wrench in accordance with the present invention.

FIG. 4 illustrates the storage tool removed from the recessed portion of the T-shaped body and the relationship between an adapter hex wrench and the socket at the link according to the present invention.

FIG. 5 is a front view of the present invention, showing the tool stored in the recessed portion of the T-shaped head of the reversible socket wrench.

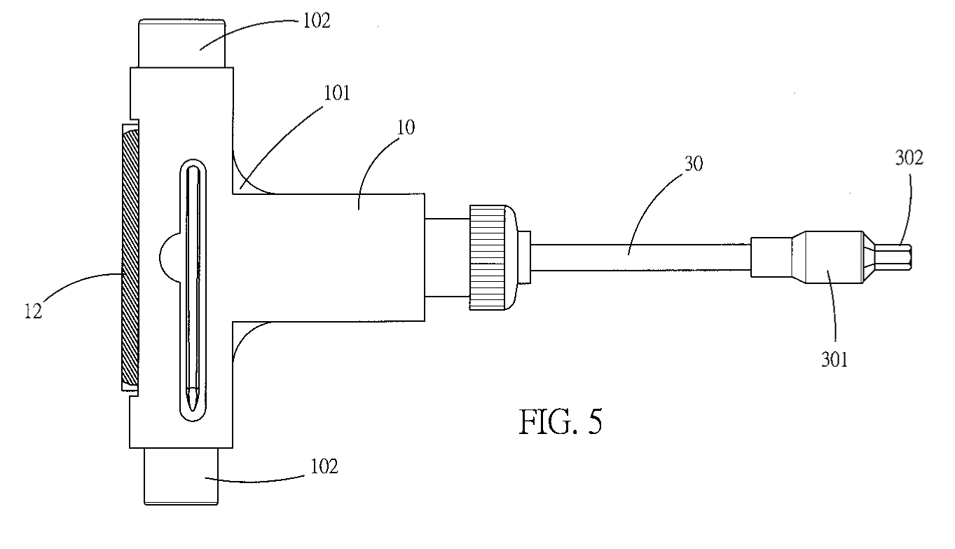

FIG. 6 is a schematic drawing of the present invention, showing one operation status of the reversible socket wrench.

FIG. 7 is a schematic drawing of the present invention, showing the slide of the ratchet wheel set in the middle position.

FIG. 8 is a schematic drawing of the present invention, showing the slide of the ratchet wheel set in the upper limit position.

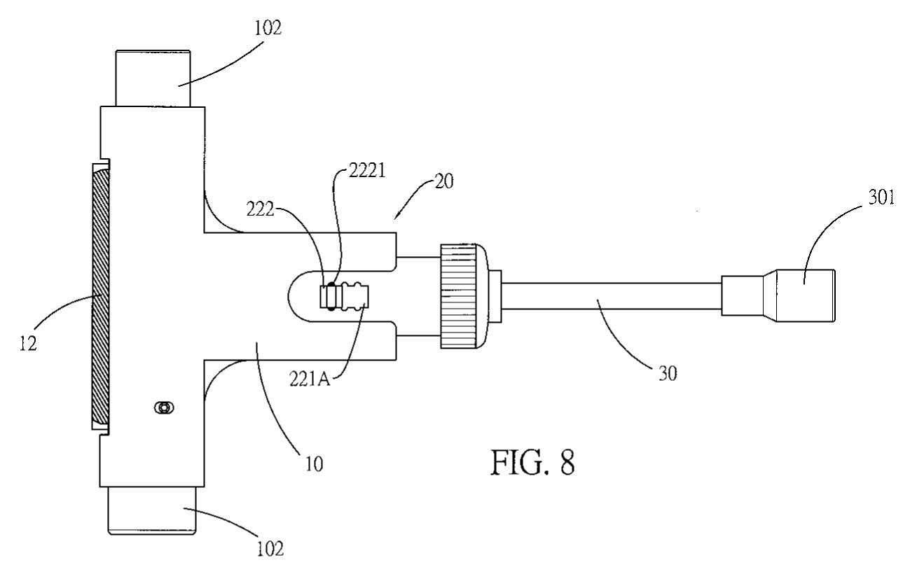

FIG. 9 is a schematic drawing of the present invention, showing the slide of the ratchet wheel set in the lower limit position.

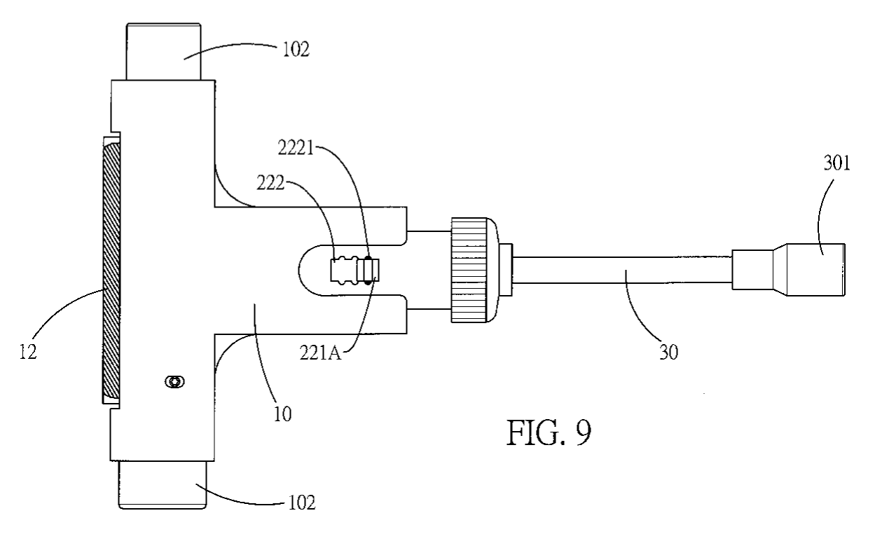

FIG. 10 illustrates a status of use of the adapter hex wrench detachably attached to the socket at said link by magnetic attraction and adapted for rotating a socket-head king pin of a skateboard.

### DETAILED DESCRIPTION OF THE PREFERRED EMBODIMENT

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

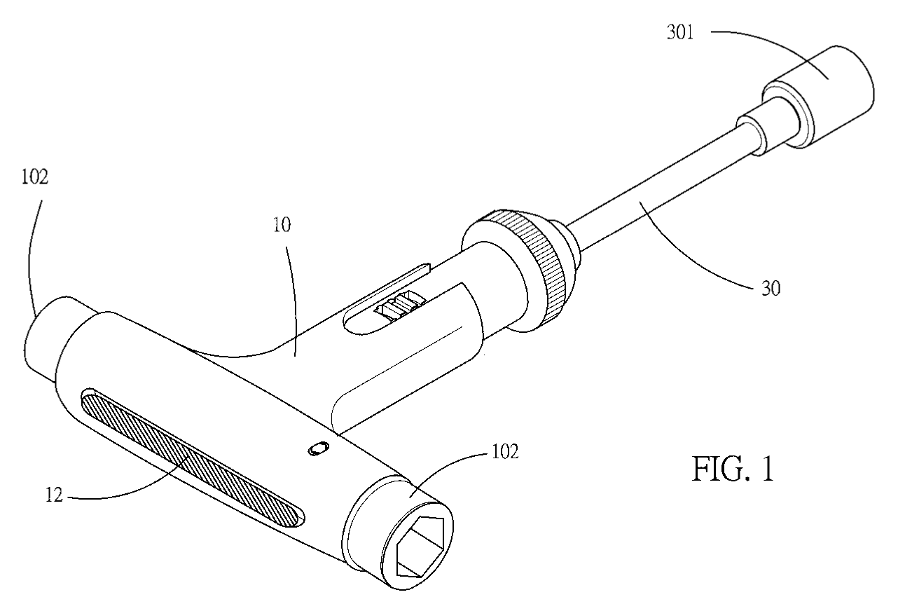

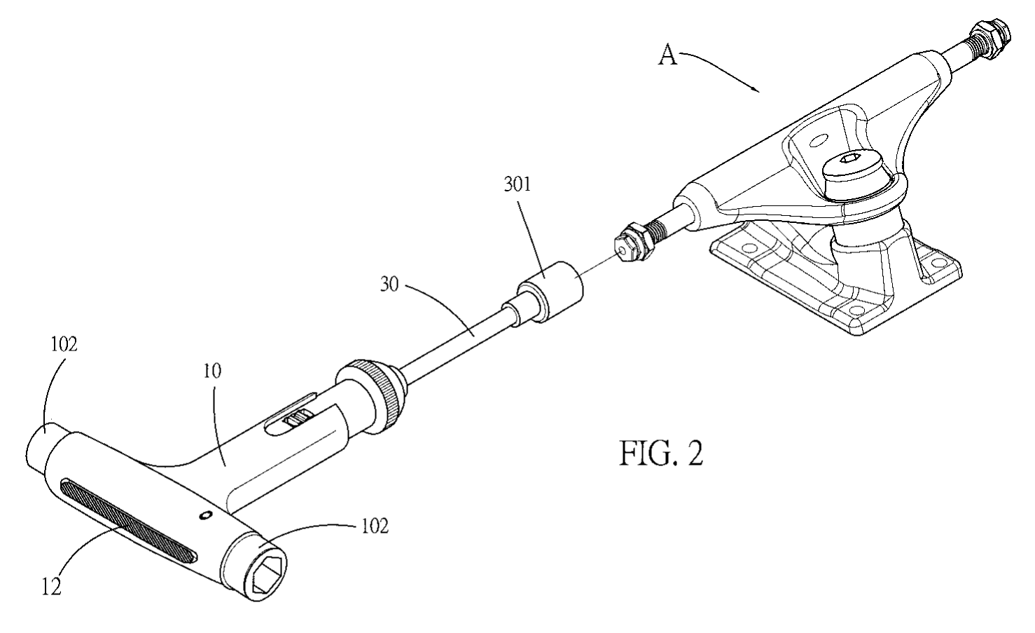

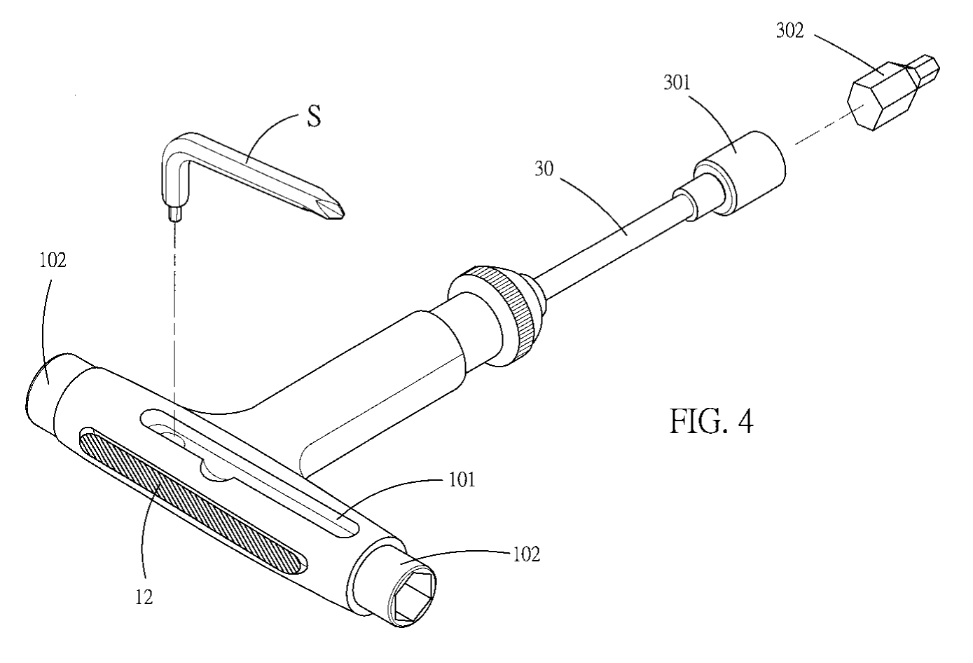

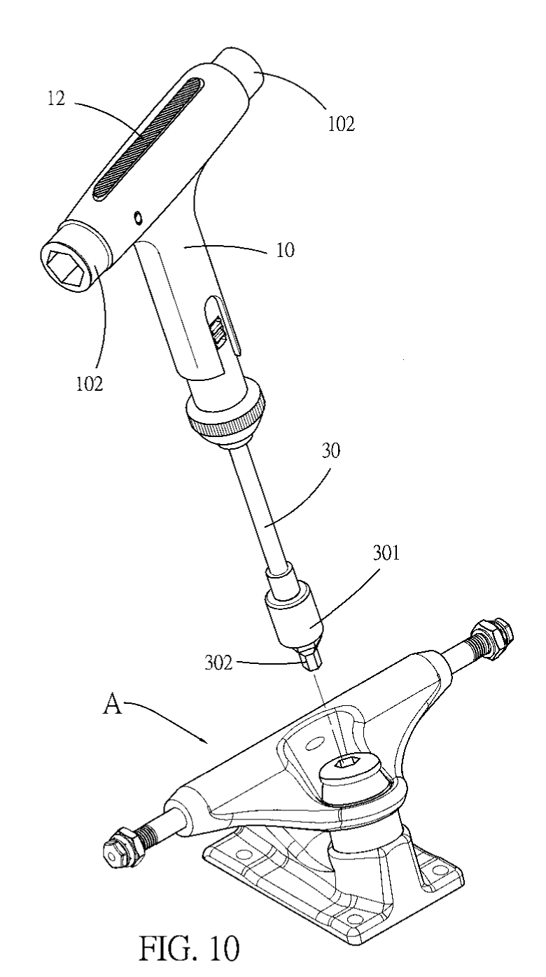

Referring to FIGS. 1 and 2, a socket wrench for fastening screws to and unfastening screws from a skateboard A in accordance with the present invention is shown comprising a T-shaped body 10. The T-shaped body 10 has a recessed portion 101 located on the transverse part thereof for receiving a tool, for example, a tool S (see FIG. 4 and FIG. 10), the tool S having a hex wrench 302 and a screw-driver respectively fixedly located on the two distal ends and adapted for rotating screws and nuts for combine the king pin and the board of the skateboard A, and two sockets 102 respectively fixedly located on the two distal ends of the transverse part. The two sockets 102 have different sizes and adapted for rotating different sizes of bolts and nuts. One socket 102 can be used to rotate the king pin of a skateboard. Further, the T-shaped body 10 has a ratchet wheel set 20 mounted in the longitudinal part thereof. The ratchet wheel set 20 enables the user to rotate a screw inwards or outwards continuously.

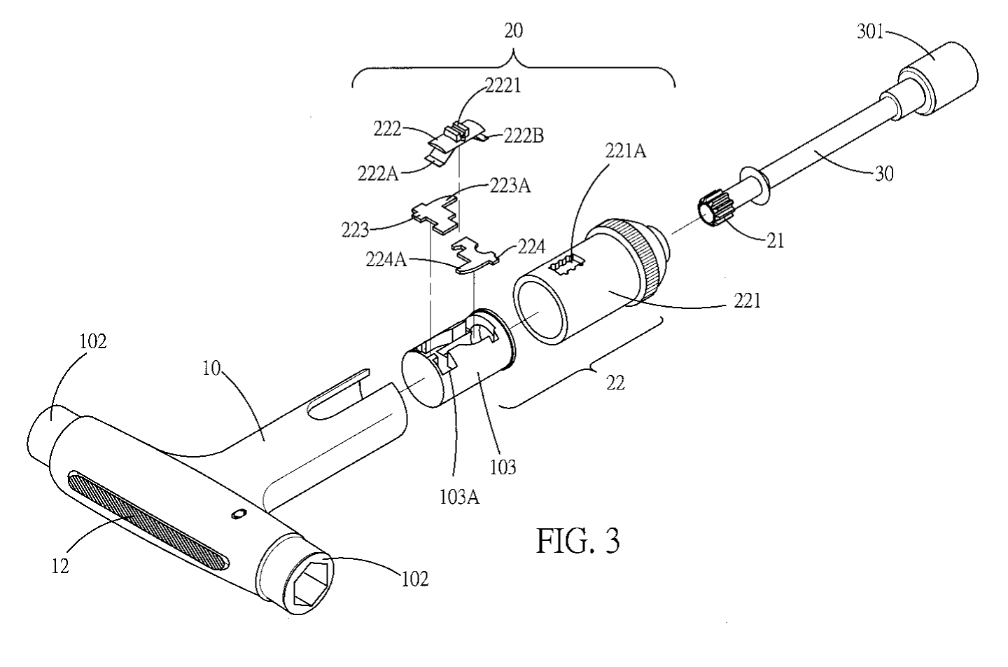

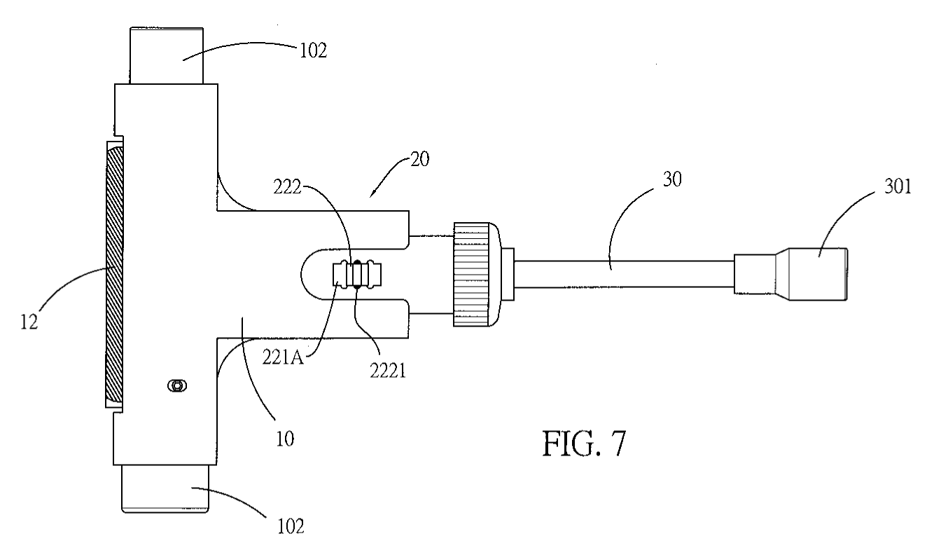

Referring to FIG. 3, the ratchet wheel set 20 includes a gear 21 and a brake unit 22. The gear 21 is mounted on one end of a link 30 which has its one end coupled to the longitudinal part of the T-shaped body 10 and its other end provided with a socket 301 for rotating a screw. The brake unit 22 is adapted to limit the direction of rotation of the gear 21. The brake unit 22 comprises a cap 221 and a slide 222 and two L-shaped braking blocks 223 and 224. The cap 221 is coupled to the link 30 around the gear 21 and capped on the free end of the longitudinal part of the T-shaped body 10, having a rectangular opening 221A. The rectangular opening 221A has two opposite long side edges serrated. The slide 222 has two protruding portions 2221 bilaterally disposed at the top side and respectively meshed with the serrated long side edges of the rectangular opening 221A, and two push plates 222A and 222B obliquely extended from the bottom side in reversed directions. The two L-shaped braking blocks 223 and 224 have a respective pawl 223A or 224A for stopping against the teeth of the gear 21. A notched barrel 103 is fastened to the free end of the longitudinal part of the T-shaped body 10 and received inside the cap 221 to accommodate the two L-shaped braking blocks 223 and 224, the notched barrel 103 having an opening 103A corresponding to the configuration of the two L-shaped braking blocks 223 and 224. The slide 222 can be moved along the serrated long side edges of the rectangular opening 221A. When the slide 22 is in the middle position inside the rectangular opening 221A (see FIG. 7), the two push plates 222A and 222B are respectively disposed at an outer side relative to the pawls 223A and 224A of the L-shaped braking blocks 223 and 224.

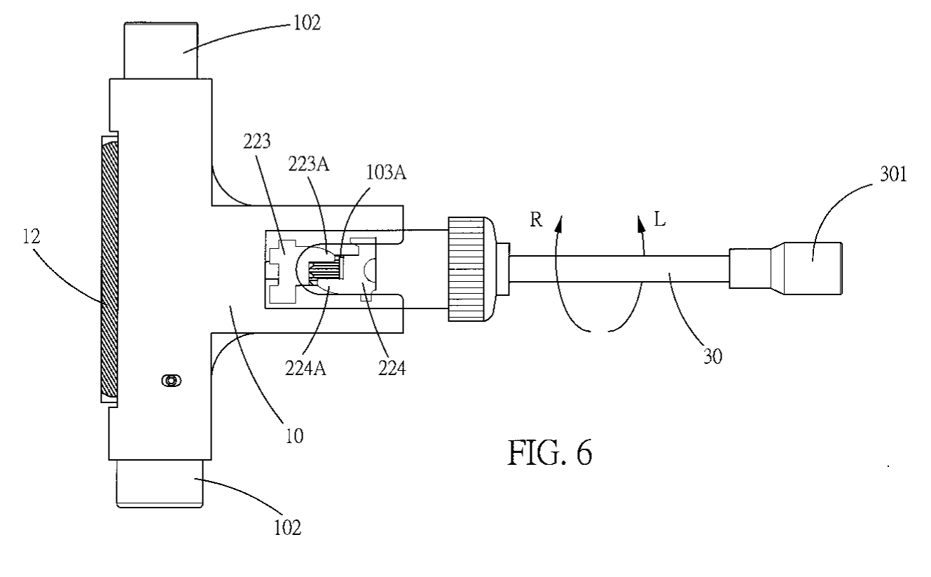

Referring to FIGS. 3˜9, when the user pushes the slide 222 forwards from the middle position inside the rectangular opening 221A to the upper limit position (one end of the rectangular opening 221A), the pawl 223A of one L-shaped braking block 223 is forced downwards by the push plate 222A and to the bottom side of one tooth of the gear 21, prohibiting rotation of the gear 21 in R direction relative to the T-shaped body 10 (see FIG. 6). At this time, the socket wrench can be used to rotate a screw in R direction continuously. If the gear is rotated in L direction, the teeth of the gear 21 will not be stopped by the L-shaped braking blocks 223, i.e. the gear can be rotated with the T-shaped body 10 in L direction freely without rotating the screw. On the contrary, when the slide 222 is pushed backwards from the middle position inside the rectangular opening 221A to the lower limit position (the other end of the rectangular opening 221A), the push plate 222A is disengaged from the pawl 223A of the L-shaped braking block 223 and returns to its former position subject to its springy material property, and at the same time the pawl 224A of the other L-shaped braking block 224 is forced downwards by the push plate 222B into engagement with the teeth of the gear 21 to prohibit rotation of the gear 21 in L direction so that the socket wrench can be driven to rotate the screw in the other direction continuously.

Referring to FIGS. 1 and 2 again, a file 12 is formed integral with the periphery of the transverse part of the T-shaped body. The file 12 is a hardened steel bar covered with a series of sharp ridges adapted to smooth the top surface or border edge of a skateboard. If the border edge of a skateboard is damaged and become uneven or sharp, the uneven or sharp border edge of the skateboard may injure the user's hands or legs accidentally. In this case, the user can use the file 12 of the socket wrench to smooth the edge.

Referring to FIG. 4 again, an adapter hex wrench 302 is detachably attached to the socket 301 at the link 30 by magnetic attraction for rotating the socket-head king pin of a skateboard.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A socket wrench for skateboard, comprising:
a T-shaped body, said T-shaped body having a transverse part, longitudinal part perpendicularly extended from said transverse part, a recessed portion located on said transverse part for receiving a tool, a first socket fixedly located on one end of said transverse part for rotating a king pin of a skateboard and a second socket fixedly located on an opposite end of said transverse part for rotating a predetermined size of screw bolts and nuts;
a file fixedly mounted on the periphery of said transverse part of said T-shaped body and extending along between the two opposite ends of said transverse part for smoothing the surface of a skateboard;
a cap capped on one end of said longitudinal part of said T-shaped body remote from said transverse part, said cap having a rectangular opening;
a link coupled to said cap, said link having a gear disposed at one end thereof and received inside said cap and a socket located on an opposite end thereof; and
a ratchet wheel set mounted in said cap for controlling direction of rotation of said link relative to said T-shaped body, said ratchet wheel set comprising a first L-shaped braking block for engaging said gear to stop said gear and said link from rotation in a first direction relative to said T-shaped body and to allow rotation of said gear and said link relative to said T-shaped body in a second direction reversed to said first direction, a second L-shaped braking block for engaging said gear to stop said gear and said link from rotation in said second direction relative to said T-shaped body and to allow rotation of said gear and said link relative to said T-shaped body in said first direction, and a slide coupled to and movable along the rectangular opening of said cap in one of a first position where said slide disengages said first L-shaped braking block from said gear and forces said second L-shaped braking block into engagement with said gear, a second position where said slide disengages said first L-shaped braking block and said second L-shaped braking block from said gear and a third position where said slide disengages said second L-shaped braking block from said gear and forces said first L-shaped braking block into engagement with said gear.

2. The socket wrench for skateboard as claimed in claim 1, wherein said rectangular opening of said cover has two opposite serrated long side edges; said slide has two protruding portions disposed at two opposite lateral sides respectively meshed with the two opposite serrated long side edges of said rectangular opening of said cover.

3. The socket wrench for skateboard as claimed in claim 1, further comprising adapter hex wrench detachably attached to the socket at said link by magnetic attraction and adapted for rotating a socket-head king pin of a skateboard.
